(19) United States
(12) Patent Application Publication
(10) Pub. No.: US 2007/0271229 A1
(43) Pub. Date: Nov. 22, 2007

(54) System and method for data searching among multiple enterprise applications

(76) Inventors: Jauder Ho, San Mateo, CA (US); Joshua L. Warsop, Chicago, IL (US); Dilip Ratnam, Cupertino, CA (US)

Correspondence Address: BAKER BOTTS L.L.P., 2001 ROSS AVENUE, SUITE 600, DALLAS, TX, 75201-2980, US

(21) Appl. No.: 11/436,728

(22) Filed: May 17, 2006

(51) Int. Cl. G06F 17/30

(52) U.S. Cl. 707/3

(57) ABSTRACT

Systems and methods are provided for searching data, which may reside in multiple computer applications, such as enterprise applications. An example system may include one or more application adapters for interfacing with the one or more computer applications. At least one processor is operable to cause the one or more application adapters to extract data from the one or more computer applications. A data transformation module receives and transforms data from the one or more application adapters. The data is transformed to a format suitable for searching by a search application. A search receives and searches the transformed data to identify one or more data files meeting one or more search criteria.

### TECHNICAL FIELD

Certain embodiments of the invention relate generally to computer data searching systems, and, more particularly, to systems and methods for searching for, and retrieving, data residing in multiple computer applications, which may be part of an enterprise network.

### BACKGROUND

An enterprise may employ multiple computer applications. Such applications may provide, for example, document creation, document management, human resources management, time entry, scheduling, etc. Some specific examples include Documentum, FileNet, SAP, Oracle, and so forth. A typical method of searching for data files in the various enterprise applications includes performing a search in each separate application using a search program directed specifically to the respective application.

### SUMMARY

Certain embodiments of the present invention may be generally directed to systems and methods for searching for, and retrieving, data and other information from various computer applications. The applications may be, for example, various applications found in an enterprise computer system. The applications may have data files, or other data, of differing formats. Certain embodiments provide a platform having adapters for extracting the data. The extracted data may be aggregated and transformed into a format usable by a search application, engine, or other searching application. The search application may be an Internet-based search engine, for example. The transformed data is transmitted to the search application and search results are returned based on one or more search criteria. In certain embodiments, information may be dynamically presented to the search application. Also, in certain embodiments, applications may be queued to determine whether a user is permitted to see information (e.g., search results) relating to the applications.

In one embodiment a system is provided for searching for files in one or more computer applications. The system includes one or more application adapters for interfacing with the one or more computer applications. The system also includes at least one processor for causing the one or more application adapters to extract data associated with data files from the one or more computer applications. The system further includes a data transformation module for receiving and transforming data from the one or more application adapters, the data being associated with the data files, the data being transformed to a format suitable for searching by a search application. The system further includes a search application coupled to the data transformation module for receiving and searching the transformed data to identify one or more data files meeting one or more search criteria.

In another embodiment an application searching platform is provided and includes at least one processor, and at least one application adapter coupled to the at least one processor and operable to interface with at least one computer application to extract data therefrom. The platform also includes a data transformer operable to convert extracted data from a first format unusable by a search application to a second format useable by the search application.

In another embodiment a method is provided for searching for data files in a plurality of computer applications. One step is providing at least one adapter for interfacing with at least one of the plurality of computer applications. Another step is accessing, through the at least one adapter, the at least one computer application. Another step is extracting data from the at least one computer application, the extracted data comprising data in a format unusable by a search application. Another step is converting the unusable data to a form useable by the search application. Another step is transmitting the useable data to the search application for searching according to at least one search parameter. Another step is receiving search results from the search application.

Certain embodiments may provide certain advantages, some of which are indicated below. It should be understood that any particular embodiment may provide some, none, or all of the described advantages.

One advantage is the ability to access different enterprise applications having files with different formats, extract the data files, and convert them to a format useable by a search application.

Another advantage is reduced complexity and increased efficiency in searching for data across multiple computer applications, which may exist in an enterprise.

Another advantage is the ability to use a commercially available search engine to search data residing in multiple computer applications, which may comprise an enterprise computer network.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates a system for data file searching in accordance with an embodiment of the present invention;

FIG. 2 illustrates a method for data file searching in accordance with an embodiment of the present invention; and

FIG. 3 is a class diagram for object-oriented programming techniques which may be employed in a searching system in accordance with an embodiment of the present invention.

### DETAILED DESCRIPTION

Various embodiments may be generally directed to systems and methods for searching for, and retrieving, data and other information from various computer applications. The applications may be, for example, various applications found in an enterprise computer system. The applications may have data files, or other data, of differing formats. Certain embodiments provide a platform having adapters for extracting the data. The extracted data may be aggregated and transformed into a format usable by a search application, engine, or other searching application. The search application may be an Internet-based search engine, for example. The transformed data is transmitted to the search application and search results are returned based on one or more search criteria.

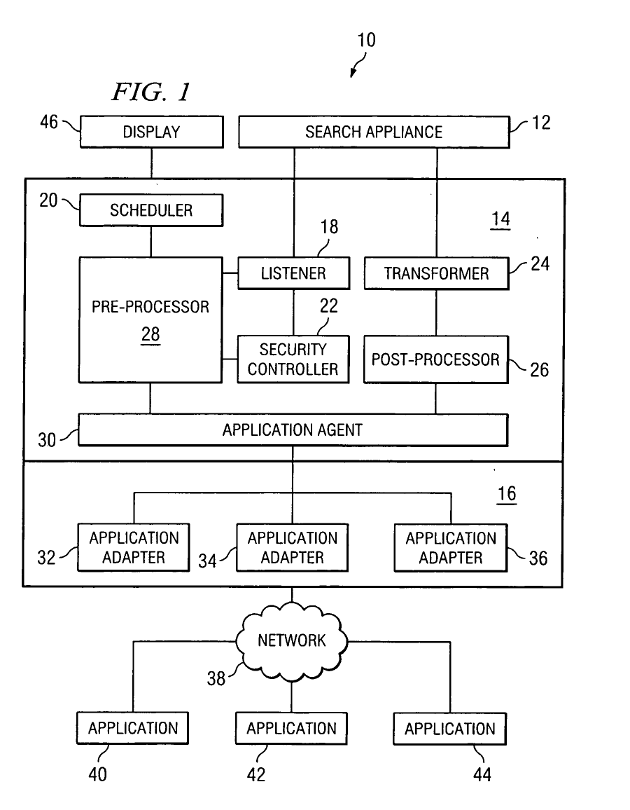

In one embodiment, as illustrated in FIG. 1 for example, a system 10 is provided for searching for documents in various enterprise applications. Although this example concerns document searching, certain aspects of various embodiments may be used for searching for any type of file stored in electronic media, databases, software programs, computer applications, etc. Also, the inventive aspects described herein are not limited to enterprise applications. For instance, other sources of data may be incorporated into various described embodiments. Such sources may include, for example, any computer application, database, program, etc. Data files may include data in any format including, for example, static, dynamic HTML, XML, graphics, multimedia, and traditional document files. Generally, the term computer application may be used to refer to the various sources of information being searched, and data file may be used to refer to information in the various sources.

System 10 includes a platform 14, which may be connected through network 38 to a plurality of enterprise applications 40, 42, and 44. Applications 40, 42, and 44 may be any computer program, database, etc. In this example, the applications are those which may be used by an enterprise in the normal course of its business. For example, the applications may include, without limitation, applications for document management, document creation, media display, Email, calendaring and scheduling, spreadsheets, human resources management, time entry, and so forth. Specific examples may include, for instance, Documentum, FileNet, SAP, Oracle, etc.

Network 38 may be any suitable network or combination of networks. Information transmitted across network 38 may include any information, in any format, which is necessary or desirable in the operation of system 10. The information may be transmitted in whole, or in combination, in any format including digital or analog, text or voice, and according to any known or future transport technologies, which may include, for example, wireline or wireless technologies. Wireless technologies may include, for example, licensed or license-exempt technologies. Some specific technologies which may be used include, without limitation, Code Division Multiple Access (CDMA), Global System for Mobile Communication (GSM), General Packet Radio Service (GPRS), WiFi (802.11x), WiMax (802.16x), Public Switched Telephone Network (PSTN), Digital Subscriber Line (DSL), Integrated Services Digital Network (ISDN), cable modem, Ethernet, and/or EV-DO technologies. The network may also comprise Internet transport. These are examples only and one of ordinary skill will understand that other types of communication techniques are within the scope of the present invention. Further, it will be understood that additional components may be used in the communication of information between the various components of system 10 and users of system 10. Such additional components may include, without limitation, lines, trunks, antennas, switches, cables, transmitters, receivers, computers, routers, servers, fiber optical transmission equipment, repeaters, amplifiers, etc.

As described in further detail below, platform 14 includes various processors, databases, modules, etc. These various components may be embodied in any suitable hardware and/or software devices, which are operable to provide the various functionalities described in connection with the example embodiments.

Platform 14 includes adapter network 16. Adapter network 16 comprises a plurality of application adapters 32, 34, and 36. Preferably there is a one-to-one correspondence between the adapters and the enterprise applications. However, the invention is not so limited. Any particular adapter may be configured to be associated with one, none, or multiple enterprise applications. And any one enterprise application may interface with one, none, or multiple adapters. In the example illustrated in FIG. 1, adapter 32 is associated with application 40, adapter 34 is associated with application 42, and adapter 36 is associated with application 44. It will be understood that other configurations are possible and fall within the scope and spirit of the various example embodiments.

Preferably, each of the application adapters 32, 34, and 36 comprises a thin layer of software executable by one or more processors within platform 14. Preferably, the adapters have no transactional capability; however, the invention is not limited to such configuration. System 10 may provide multiple instances of any particular adapter. During operation, the adapters connect interface with the respective enterprise applications to extract data therefrom. Preferably, the data is extracted in the form in which is resides at the respective application. One or more criteria may be preestablished for enabling an adapter to determine which information to extract from a respective application. In one example embodiment, the adapter layer 16 includes a data access layer (not expressly shown), which accesses data from various applications by using various API techniques (which may be particular to the respective application), Java objects and XML parsers. For example, with respect to a Documentum application, the data access layer may use Documentum Foundation Class (DFC) methods.

Platform 14 includes one or more listener modules 18. A listener module may receive calls from search application 12 (e.g., as part of a security credentials validation and lookup as described elsewhere herein). The same listener module, or a different listener module (not expressly shown) may receive calls for dynamic lookups.

Listener module 18 is coupled to pre-processor 28, which in turn is coupled to application agent 30. Pre-processor 28 is operable to invoke the various adapters through application agent 30. Pre-processor 28 may use various information as input to determine whether, when, and under which conditions and/or criteria to invoke adapters 32, 34, and 36. As illustrated pre-processor 28 is also coupled to scheduler 20 and security controller 22. Thus, pre-processor 28 may receive input from listener 18, scheduler 20, and/or security controller 22 to determine the various parameters of operation of the adapters, and thus the operation of system 10.

Among other things, scheduler 20 may provide one or more time criteria for use in controlling the operation of the searching functions of system 10. For example, scheduler 20 may accept from a user certain date and/or time parameters, according to which the various enterprise applications will be searched. For instance, it may be desired that various enterprise applications are periodically searched on certain days or at certain times of day.

Among other things security controller 22 may provide certain parameters according to which users may or may not perform the various functions and operations of system 10. In one example, security controller 22 maintains certain information associated with a plurality of users. Certain users may be authorized to search only application 40, while certain other users are authorized to search all enterprise applications. Security controller 22 dictates which users will be able to perform which searches based on this information. In other situations, security controller 22 may govern which users are able to view search results. Search results may include the actual data files (e.g., documents) resulting from the search. Search results may also include information associated with the data files. Such information may include, for example, date, author, and title information. In certain configurations, security controller 22 may permit a particular user to view indication information associated with data files in the search results, but may prohibit the same user from viewing the data files themselves. In other scenarios, security controller 22 may prohibit a particular user from viewing any information associated with the search results including the data files or any information indicative of the existence or content of the data files. Security controller may be used to allow a user of group of users access to search results, while prohibiting access to another user or other group of users. In another embodiment, the security controller 22 extracts information regarding user credentials from a source. Optionally, security controller 22 may receive the information from another system component, which extracts the credentials from the source. The source may be one or more databases, for example. According to another example, the source may comprise one or more of the enterprise applications. Preferably, the credentials indicate whether a user is allowed to perform certain searching functions and view search results associated with one or more of the enterprise applications. Security controller 22 compares the credentials with data maintained by security controller 22 to determine whether a particular user may perform search activities and/or view search results.

Application agent 30 is coupled to pre-processor 28 and to the network 16 of application adapters 32, 24, and 36. Agent 30 may, according to certain configurations, function as an aggregator for data extracted from the various enterprise applications by the adapters. Agent 30 may collect the data files (or other extracted information) and provide the extracted data to post-processor 26. Data may undergo a first conversion prior to be forwarded to post-processor 26. Post-processor 26 may generate files, which are suitable for searching by a search application. The files may then be forwarded to a transformer 24 for additional conversion to a format specifically adapted to be recognized and processed by the particular search application 12. In one example, data files are converted to Base64 format prior to being forwarded to post-processor 26, and post-processor 26 converts the Base64 files to generic XML files. Transformer 24 then converts the platform XML files to search-appliance-specific XML files.

In the illustrated example, the search application 12 may be an Internet-based search engine such as the Google Search Application (GSA). In such a scenario, the transformer 24 would convert the platform XML files into GSA-specific XML files for processing and searching using the GSA. It should be noted that any suitable search application may be incorporated into various embodiment of the invention. It should also be noted that systems according to certain embodiments may employ more than one search application, which may operate in conjunction with one another. The operation may be parallel or serial.

Preferably, during the conversion process, a record locator is included in each data file. This may occur at any point in the process. For example, extracted data files may be provided with a record locator upon extraction by the adapter(s). Optionally, the application agent, post-processor, transformer, or other component (either shown or not expressly shown) may provide the data files with record locators. The record locators assist in the assembly and display of the search results by, for example, display 46.

Display 46 may be any suitable display for display electronic information. Display 46 may comprise, for example, one or more computer screens, personal data assistants, mobile communication devices, video thermals, printers, etc. In certain embodiments, an interface is provided to gain access to, and control the operation of, display 46 and other components of system 10. For example, in reviewing search results, a user might wish to access both public and private information within or otherwise associated with the search results based on the user's authorization status. Accordingly, in one example, a design pattern may be defined around manipulations of suitable Extensible Stylesheet Language Transformations (XSLT) to provide a user-friendly interface to enable this functionality. In this example, one advantage of such a design pattern may include the emphasis on the context of use of each element in the library. Designers, when considering a new design, may use the context description to determine whether a particular pattern is appropriate. Simplicity of usage may increase effectiveness and productivity.

Search application 12 is operable to search the data it receives from platform 14. Operation of the search application 12 is generally known and the details of operation are, therefore, omitted. Search application 12 returns search results to platform 14, which may then display the results on display 46. Optionally, search application 12 may transmit the search results directly to display 46, to another component such as a remote processor for further processing prior to display, or to one or more databases for storage. The search results may be in any form including, without limitation, content, record information and file identification information. The results may also be returned from search application 12 in any data format. In some instances the data returned from search application 12 must undergo further conversion prior to being viewable on a display. Preferably, system 10 allows a user to manipulate the search results according to any number of parameters including record ranges, date and time ranges, numerical and alphabetical orders, subject matter, the particular enterprise application associated with the file, etc.

It should be noted that although there is only an instance of platform 14 illustrated in FIG. 1, the invention is not so limited. Certain embodiments may incorporate multiple instances of platform 14 (or other components), for example, on a single server or multiple servers.

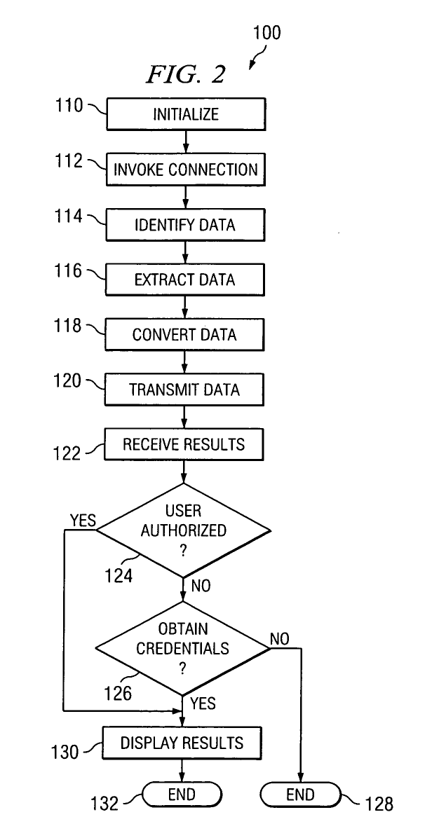

In another example embodiment, illustrated in FIG. 2, a method 100 is provided for searching for data files residing in a plurality of computer applications. Again, as described above, the terms data files and computer applications are not meant to be limiting. As with system 10 illustrated in FIG. 1, the various inventive aspects of method 100 may apply to searching any sources of electronic information for data in any format. Also, the various method steps may be performed by any suitable component or combination of components, which is, or are, operable to perform the various functionality of the method 100.

At step 110, a searching system is initialized. This may involve any of a variety of actions including start-up actions, data class setup, login and other security activities, software updates, and debugging services.

At step 112, a connection is invoked between a searching system platform and at least one computer application. Preferably, a connection is established with a plurality of computer applications, which as described herein may be any of a variety of computer applications including commercially available or proprietary enterprise applications. The connection may be established by any of the techniques, and using any of the components, already described herein. For example, the connection may be invoked by a pre-processor in a search system platform. The pre-processor may accept various parameters as input to determine whether, and under what conditions, to connect the platform to the computer application(s). It should be noted that the term “platform” is not meant to be limiting with respect to the configuration of components used to perform the functionality of the various steps of method 100. Any suitable combination and arrangement of components may be employed. In one example, the connection is established through the use of an application agent, through a network of application adapters, through a communications network, and to a plurality of enterprise applications. In an example embodiment, the method 100 is accomplished using object-oriented programming techniques. In this scenario, the connection step may involve unpacking one or more connection objects, logging in to begin a search session, and returning a search session as a Java object.

At step 114, data in the one or more computer applications is identified. This step may involve preliminary searching (including, for example, building a search query string) by one or more processors to determine identifying information for data files to be searched and determining whether data in the computer applications is qualified for searching. For example, the identification step may involve determining record location information for all files of a particular format such as .ppt (PowerPoint) files. The indemnification step may also provide a number of qualified files or records and may generate information regarding the volume, location, etc. of data that will be extracted for searching by a search application.

At step 116, data is extracted from the computers application(s). This may be accomplished, for example, by the techniques described above in connection with system 10. For example, one or more application adapters may extract the data from the computer application(s). According to one example, file content data is obtained for a collection of name/value pairs, each of the name/value pairs being associated with a single content item. Certain conversion techniques, as described herein, may be performed as part of the extraction step.

At step 118, the data is converted. This may involve any number of components, steps, and different conversion techniques, such as those described herein, for example. In once scenario, an application agent aggregates the extracted data and performs an initial conversion of at least some of the data to a form useable by a post-processor. The post-processor may further convert the data to a different format, such as an XML format, prior to transmitting the data to a transformer. The transformer may further convert the data to a format specific to the particular search application(s) being used by the search system. For example, the transformer may convert the data to a GSA-specific format in the event the search method involves the use of a Google Search Application. These are examples only, and it should be noted that any suitable conversion techniques may be employed as long as the extracted data is ultimately converted to a format usable by the search application(s).

At step 120, the data is transmitted to a search application. The search application may be any search component operable to search electronic data. In one example, the search application is a remote, Internet-based search engine, such as a Google Search Application. The information may be transmitted to the search application via any communications techniques and across any communications network or component. The search application preferably performs searching of the converted data according to its normal methods of operation.

At step 122, search results are received. The search results may be transmitted from the search application to the search platform. The search platform may then display the results on one or more displays. Optionally, the one or more displays may receive the search results directly. The search results may be in any suitable format. Accordingly, the results may be returned from the search application in a form suitable for viewing by a user without further processing. Alternatively, one or more platform processors, or remote processors or other components, may receive the search results and convert the results into a viewable format prior to the results being transmitted to the display(s).

At step 124, a security process may be performed. In one example scenario, a security query is initiated. This may be performed according to any of the various techniques described herein. If the security query is positive, then the method proceeds to step 130. If the security query is negative, then the method may proceed to step 126 for further security processing.

At step 126, an attempt is made to obtain the necessary information to authorize the user to view the results. For example, the user may be prompted to provide one or more security inputs. The system may then evaluate the security inputs to determine whether the security check is positive or negative. If positive, the method proceeds to step 130. If still negative, the method ends at step 128. It should be noted that the security step(s) may be performed at different points during the method 100. For example, the security checks may be performed prior to the connections being established in step 112.

At step 130, the results may be displayed. The display step may be performed at least partially under the control of one or more users. For example, a user may choose how he or she would like the search results to be displayed. For example, a user may first be presented with a listing of data files. The listing may include selected identifying/record locator information regarding the files returned as search results. The user may then opt to view the actual content of one or more files. Also, the user may elect to manipulate and/or organize the results according to one or more parameters, which may be predetermined or established by the user. The method ends at step 132.

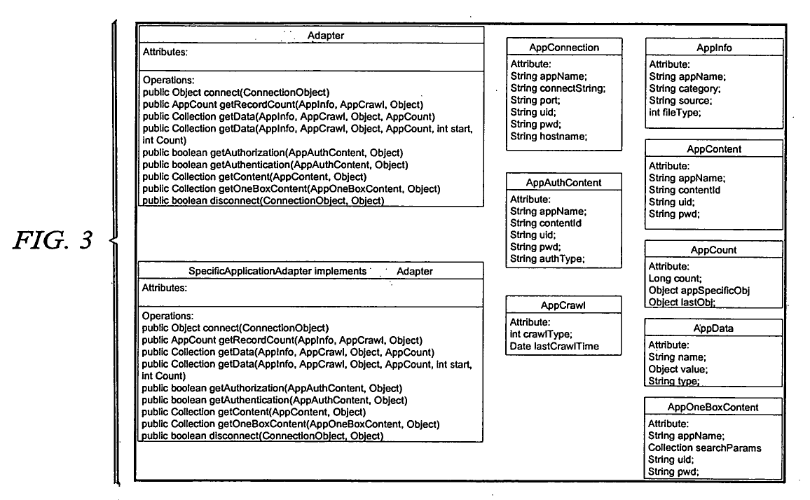

In one specific example, as in the case where a particular enterprise application known as Documentum is involved, the method 100 may be performed according to the following example processes. Some examples of the various object classes relating to the steps are illustrated in FIG. 3. In FIG. 3, a class diagram is provided showing Service and Data Access Object (DAO) layers. DctmAdpaterService class is the Service layer and defines the set of available operations and their interfaces. Access from the platform (sometimes referred to as Extension Platform) or any other source to the Adapter may be made through this layer. The DctmAdapterDAO class is the Data Access layer. The DAO uses DFC/API methods, Java objects and an XML parser to access configuration files from a Documentum repository.

Certain steps for this specific configuration include:

A. init

Initialize the class and the Logging and Debugging service for the Adapter.

B. connect

Connect to the Documentum server based on information passed in the ConnectionObject parameter. The connection information is passed back to the Adapter and is returned as a Java object. The function performs the following steps:
Unpacks the ConnectionObject
Logs in and gets session
Returns session as Java Object

C. getRecordCount

Return the count of content records that are qualified for a particular category of information. The function performs the following steps:
Builds query string
Queries repository
Returns count and collection of object Ids as Java Object

D. getData

Return the content data of name/value pairs. Each collection holds one content item. The function performs the following steps:
Gets repository version
Extracts data from FIXML filestore if the Documentum version is 5.3 or higher
Extracts data using DFC and converts content to Base64 if the Documentum version is between 5.0 and 5.2
Returns with error code if the Documentum version is below 5.0—the repository not supporter

E. getData

Return content records for a specified range. The content data is in a collection of name/value pairs. Each collection holds one content item. The function performs the following steps:
Gets repository version
Extracts data from FIXML filestore if the Documentum version is 5.3 or higher
Extracts data using DFC and converts content to Base64 if the Documentum version is between 5.0 and 5.2
Exits program if the Documentum version is below 5.0

F. getAuthorization

Return “true” if the user is authorized to view the specified content, and “false” if not. The function performs the following steps:
Queries repository to ensure that user has access to the object
Returns “true” if user has access, and “false” if otherwise

G. getOneBoxContent

Return a collection of content record, based on a pre-configured DQL statement. The specified search or DQL is passed in AppOneBoxContent object along with the connection information retrieved from the connect call. The function performs the following steps:
Queries repositories using DQL
Gets attributes asked in the DQL
Returns result in Java Collection Object

H. getContent

Return the specified content as a collection of name/value pairs. This method is used with OneBox functionality and whenever Webtop web client is not available to display the content. The function performs the following steps:
Queries repository
Gets content and convert to Base64
Returns content in Java Object

I. disconnect

Disconnect the specified session from the Documentum repository. The function performs the following step:
Disconnects from the repository

In another embodiment, the search application(s) are downloadable (e.g., from a website) or otherwise installable on a computer platform. The computer platform having the downloaded appliance may be the search platform described herein, or another computer platform. In one example, the computer platform on which the search application is installed is a user's desktop or laptop computer. In a specific example, the user may install a Google Desktop search engine product and an interface may be established between the search platform (e.g., the platform described in connection with system 10) for the performance of search activities. Other search applications, such as Side Bar (a plug-in product) may be similarly incorporated.

In still another embodiment, a proxy agent from the security module may be moved to the laptop or desktop computer of a user, or to such other computer platform that may host a portion of the searching system.

In yet another embodiment, the search application, results display, and/or other components may reside wholly, or partially, on a mobile communication device. The mobile communication device may comprise any suitable device having electronic information processing capability, such as a mobile phone, mini computer, or personal data assistant. Preferably, the mobile communication device has a display for displaying search results.

Although an embodiment of the invention and its advantages are described in detail, a person skilled in the art could make various alterations, additions, and omissions without departing from the spirit and scope of the present invention as defined by the appended claims.

1. A system for searching for files in one or more computer applications, the system comprising:
one or more application adapters for interfacing with the one or more computer applications;
at least one processor for causing the one or more application adapters to extract data associated with data files from the one or more computer applications;
a data transformation module for receiving and transforming data from the one or more application adapters, the data being associated with the data files, the data being transformed to a format suitable for searching by a search application; and
a search application coupled to the data transformation module for receiving and searching the transformed data to identify one or more data files meeting one or more search criteria.

2. The system of claim 1, wherein the one or more application adapters comprises a plurality of application adapters for interfacing with a plurality of computer applications.

3. The system of claim 2, wherein each of the plurality of application adapters interfaces with one computer application.

4. The system of claim 2, wherein at least one of the plurality of application adapters interfaces with at least two computer applications.

5. The system of claim 1, further comprising a platform, the platform comprising the at least one processor and the data transformation module.

6. The system of claim 5, wherein the platform further comprises at least one application adapter.

7. The system of claim 6, wherein the platform is coupled to one or more computer applications through a network.

8. The system of claim 1, wherein the one or more computer applications comprise enterprise applications disposed on one or more enterprise servers, and wherein the search application comprises a search engine comprising one or more servers remote from the one or more enterprise servers.

9. The system of claim 1, further comprising a security module for enabling a user to view results from the search application according to one or more security criteria.

10. The system of claim 9, wherein if the one or more security criteria are not met, the user may view information associated with the search results, but may not view content of the search results.

11. The system of claim 9, wherein if the one or more security criteria are not met, the user may not view any information associated with the search results.

12. The system of claim 9, wherein the search results comprise document files, and wherein the user is only able to view the document files if the one or more security criteria are met.

13. The system of claim 9, wherein the search results comprise document files and data and indication data associated with the document files, and wherein the user is unable to view either the document files or the indication data unless the one or more security criteria are met.

14. The system of claim 9, wherein the security module checks at least one of the one or more computer applications for a data packet associated with a user to determine whether the user is permitted to view information associated with the search results.

15. The system of claim 14, wherein the data packet comprises a software cookie.

16. The system of claim 14, wherein if a data packet exists associating the user with the respective computer application, then the user is permitted to view information associated with the search results.

17. The system of claim 14, wherein if a data packet does not exist associating the user with the respective computer application, then the system queries the user for input regarding one or more security criteria.

18. The system of claim 9, wherein the security module compares data received from the one or more computer applications and compares the received data with stored data, the comparison being at least one factor used in determining whether a user is permitted to view information associated with the search results.

19. The system of claim 1, further comprising a scheduling module operable to control the timing of a search performed by the system.

20. The system of claim 1, further comprising an application agent operable to aggregate data extracted from the one or more computer applications.

21. The system of claim 20, wherein the application agent is further operable to convert the extracted data to a form usable be a processor.

22. The system of claim 20, further comprising a conversion processor coupled to the application agent and operable to convert data to a format useable by a search application.

23. The system of claim 22, wherein the conversion processor is operable to convert data to XML format.

24. An application searching platform, comprising:
at least one processor;
at least one application adapter coupled to the at least one processor and operable to interface with at least one computer application to extract data therefrom;
a data transformer operable to convert extracted data from a first format unusable by a search application to a second format useable by the search application.

25. An application searching platform, comprising:
at least one processor; and
at least one security module coupled to the at least one processor and operable to execute at least one security information request for security information from at least one computer application, the security information used to determine whether a user is permitted to view search information associated with the at least one computer application.

26. A method of searching for data files in a plurality of computer applications, the method comprising:
providing at least one adapter for interfacing with at least one of the plurality of computer applications;
accessing, through the at least one adapter, the at least one computer application;
extracting data from the at least one computer application, the extracted data comprising data in a format unusable by a search application;
converting the unusable data to a form useable by the search application;
transmitting the useable data to the search application for searching according to at least one search parameter; and
receiving search results from the search application.

27. The method of claim 26, wherein the at least one computer application comprises a plurality of computer applications having first and second data associated therewith, the first and second data having different formats.

28. The method of claim 26, further comprising extracted data and converting the extracted data to a single format.

29. The method of claim 26, wherein the search application is hosted remotely from the at least one computer application.

30. The method of claim 26, wherein the search application is hosted remotely from a platform comprising the at least one adapter.

31. The method of claim 26, further comprising retrieving at least one piece of security data associated with a user and comparing the at least one piece of security data with stored data to determine whether a user is permitted to perform at least one step in the method.
